(19) United States
(12) Patent Application Publication
(10) Pub. No.: US 2010/0037587 A1
(43) Pub. Date: Feb. 18, 2010

(54) Turbojet Nacelle Equipped With Means For Reducing The Noise Produced By Said Turbojet

(76) Inventors: Guy Bernard Vauchel, Le Havre (FR); Jean-Fabrice Marcel Portal, Le Havre (FR)

Correspondence Address: MATHEWS, SHEPHERD, MCKAY, & BRUNEAU, P.A., 29 THANET ROAD, SUITE 201, PRINCETON, NJ, 08540, US

(21) Appl. No.: 12/295,908

(22) PCT Filed: May 3, 2007
(86) PCT No.: PCT/FR2007/000755

§ 371 Date: Jul. 7, 2009

(30) Foreign Application Priority Data
May 18, 2006 (FR) 0604433

(51) Int. Cl. F02K 3/02; F02C 9/00

(52) U.S. Cl. 60/226.2; 60/773

(57) ABSTRACT

This nacelle (201) for an aircraft turbojet includes an internal downstream structure (13) and an external downstream structure (15) delimiting an interior flow channel (14) for a secondary flow generated by the turbojet, the external downstream channel comprising at least one distribution line (18, 19a, 19b, 20) terminating at the outlet of the turbojet and being intended to be connected to a sound-reducing fluid supply source arranged upstream from the external downstream structure. This external downstream structure (15) is equipped with a thrust reversal device. The distribution line includes at least one supply line (19a, 19b) capable of ensuring the passage of said fluid from said supply source towards the outlet of the turbojet at least when said reversal device is in its off position.

The present invention relates in particular to a turbojet engine nacelle equipped with means of reducing the noise generated by said turbojet.

An aircraft is powered by one or more propulsion units comprising a turbojet engine housed in a tubular nacelle. Each propulsion unit is attached to the airplane by a pylon generally located under a wing or on the fuselage.

Conventionally, a nacelle has a structure comprising an air intake upstream of the engine, a central section intended to surround a fan of the turbojet, and a downstream section surrounding the combustion chamber of the turbojet. A primary nozzle may then be fixed at the outlet of the turbojet engine.

If required, the downstream section of the nacelle may house a thrust reverser device the purpose of which is, when the aircraft is coming in to land, to improve the ability of the aircraft to brake, by redirecting at least some of the thrust generated by the turbojet engine forward.

Modern nacelles are intended to house bypass turbojet engines capable, via the blades of the rotating fan, of generating a hot air stream (also known as the primary stream) that comes from the combustion chamber of the turbojet engine, and a cold air stream (the secondary or bypass stream) that flows around the outside of the turbojet engine through an interior flow passage also known as a duct, formed between the downstream internal structure and the downstream external structure of the nacelle. The two air streams are ejected from the turbojet engine via the downstream end of the nacelle.

In recent nacelles such as this, the thrust reverser device obstructs the cold stream duct and directs this cold stream toward the front of the nacelle, thereby generating a reverse thrust which combines with the braking provided by the wheels of the aircraft.

The means employed to reorient the cold stream in this way vary according to the type of thrust reverser. However, in all cases, the structure of a thrust reverser comprises moving cowls that can be moved between, on the one hand, a deployed position in which they open within the nacelle a passage that is intended for the deflected stream and, on the other hand, a retracted position in which they close off this passage. These cowls may perform a deflection function or may simply activate other deflection means.

In the case of a cascade-type thrust reverser which comprises cascades of vanes, the air stream is reoriented by cascades of deflection vanes, the cowls simply having the function of sliding in order to uncover or re-cover these cascades. Additional blocking doors, activated by the sliding of the cowling, generally close off the duct downstream of the cascades so as to optimize the reorientation of the cold stream.

Furthermore, a common ejection nozzle may be fitted downstream of the thrust reverser device with which a combined-stream nacelle is equipped.

The geometry of the downstream section of the nacelle, whether or not this nacelle is equipped with a thrust reverser device, is generally axisymmetric and continuous along a plane practically perpendicular to the longitudinal axis of the nacelle. Streamlining shroud elements supported by the engine downstream of its makeup complete the aerodynamic design of the nacelle.

In all cases, the way in which the air expelled by the nacelle suddenly comes into contact with the surrounding external air generates a great deal of noise.

It has been proposed for example, particularly in patent US 2003/213227, that this unwanted noise be reduced by making a scalloped cutout at the outlet of the downstream section of the nacelle. This cutout is commonly known as “serrations” and the serrations, the shapes of which may vary, contribute to better homogenization of the expelled air with the external wash around the nacelle. This design allows more gradual mixing between the two streams, reducing the noise levels generally encountered in conventional configurations.

Once the geometric configuration has been fixed, the shape of the serrations cannot be modified in operation. The triangle shape often proposed presents ends that are delicate to impact or to deformation, particularly when equipment is being moved around the nacelle, it being possible that an impact that displays no apparent damage can disrupt the outlet section and reduce the efficiency of the device. Maintenance thereby becomes even trickier to perform when carrying out a repair or when changing part of a serration, for the very same reasons of being able to set the ejection cross section that needs to be maintained.

In addition, the downstream part of the nacelle is usually treated to resist attachment of a bolt of lightning, by adding a metal reinforcement which is often added on. Now, having serrations makes it more difficult to perform the reinforcing operation.

Elsewhere it has been proposed, particularly in documents EP 1 580 417, EP 1 580 418, US2004/237501, to provide a nacelle for an aircraft turbojet engine, comprising a downstream internal structure and a downstream external structure delimiting an internal duct through which a secondary or bypass stream generated by the turbojet engine flows, the downstream external structure comprising at least one distribution circuit opening to the outlet of the turbojet engine and intended to be connected to a source supplying noise-reduction fluid positioned upstream of the downstream external structure.

As is known per se, the outlet of the noise-reducing fluid makes it possible to produce an aerodynamic barrier that performs the same function as the fixed serrations, that is to say that makes the air leaving the interior duct of the nacelle mixed more gradually with the surrounding external air. This gradual mixing reduces the noise generated by the operation of the turbojet engine.

It is a particular object of the present invention to adapt a noise reduction device such as this to suit a nacelle fitted with a thrust reverser.

This object of the invention is achieved using a nacelle for an aircraft turbojet engine, comprising a downstream internal structure and a downstream external structure delimiting an internal duct through which a secondary or bypass stream generated by the turbojet engine flows, the downstream external structure comprising at least one distribution circuit opening to the outlet of the turbojet engine and intended to be connected to a source supplying noise-reduction fluid positioned upstream of the downstream external structure,

this nacelle being notable in that the downstream external structure is equipped with a thrust reverser device capable alternately of switching from a closed position, in which it allows said stream to flow through the internal duct as a direct jet, to an open position in which it uncovers an opening in the downstream external structure so as to allow said stream to be reoriented into a deflected jet through activation of thrust reverser means,

and in that said distribution circuit comprises at least one supply pipe capable of conveying said fluid from said supply source to the turbojet engine outlet at least when said reverser device is in its closed position.

By virtue of the presence of a supply pipe such as this, the device that reduces noise by emitting a noise-reducing fluid is compatible with a nacelle fitted with a thrust reverser.

According to other optional features of this nacelle:
said supply pipe is able to connect the supply source to at least one distribution pipe;
the distribution pipe is of toric configuration;
at least one diffuser is connected to each distribution pipe, downstream;
each diffuser has a shape tailored to suit the tapering lines of the downstream end of said nacelle;
each diffuser is funnel-shaped with its cavity unencumbered or provided with internal arrangements that form deflectors;
each diffuser comprises a plurality of tubings that may differ from one another in terms of their diameter, routing and orientation;
each diffuser is coupled to an autonomous command and control system capable of regulating the rate of flow of fluid passing through said diffuser;
each diffuser has a downstream end to which there is attached a spoiler so that the stream leaving the diffuser can be oriented toward the intrados or toward the extrados;
the supply pipe is split into at least two telescopic pipes capable alternately of switching the thrust reverser device from its closed position to its open position;
there are means for providing sealing between the two telescopic pipes at least when the thrust reverser device is in its closed position;
the supply pipe comprises an upstream end equipped with coupling means capable of allowing clean contact with an interface connected directly or indirectly to the supply source.

The present invention also relates to an installation comprising a nacelle as mentioned in the foregoing, notable in that it comprises a fluid supply source connected to each supply pipe.

According to other optional features of this installation:
this nacelle comprises at least one command and control device for regulating the rate of flow of fluid delivered by said supply source to each supply pipe;
each command and control device contains cooling means capable of cooling the fluid delivered by the supply source.

The present invention also relates to an aircraft comprising at least one installation as mentioned in the foregoing, notable in that the supply source consists of the turbojet engine.

According to other optional features of this aircraft:
the engine is in communication with the distribution circuit via at least one supply strut;
the supply source is situated onboard said aircraft.

The invention will be better understood with the aid of the detailed description given hereinbelow with reference to the attached drawing in which:

FIG. 1 is a schematic partial perspective view of a traditional serrated nacelle attached to a wing of an aircraft;

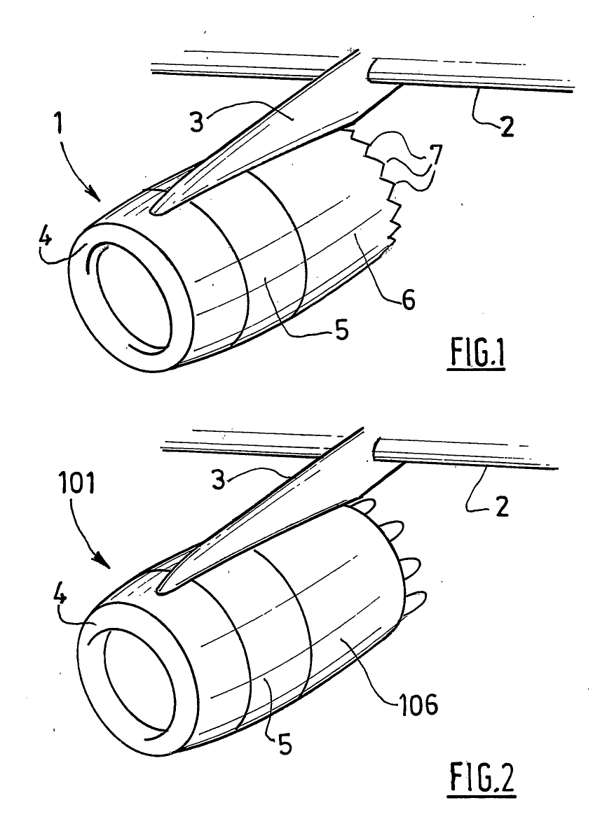

FIG. 2 is a view similar to FIG. 1 but of a nacelle according to the invention;

FIG. 3 is a schematic partial view in longitudinal section of the engine that constitutes the source that supplies the air;

FIG. 4 is a schematic view in longitudinal section of a nacelle according to the invention equipped with a fixed downstream external structure;

FIG. 5 is a partial diagrammatic plan view of a longitudinal section of a first alternative form of embodiment of a diffuser;

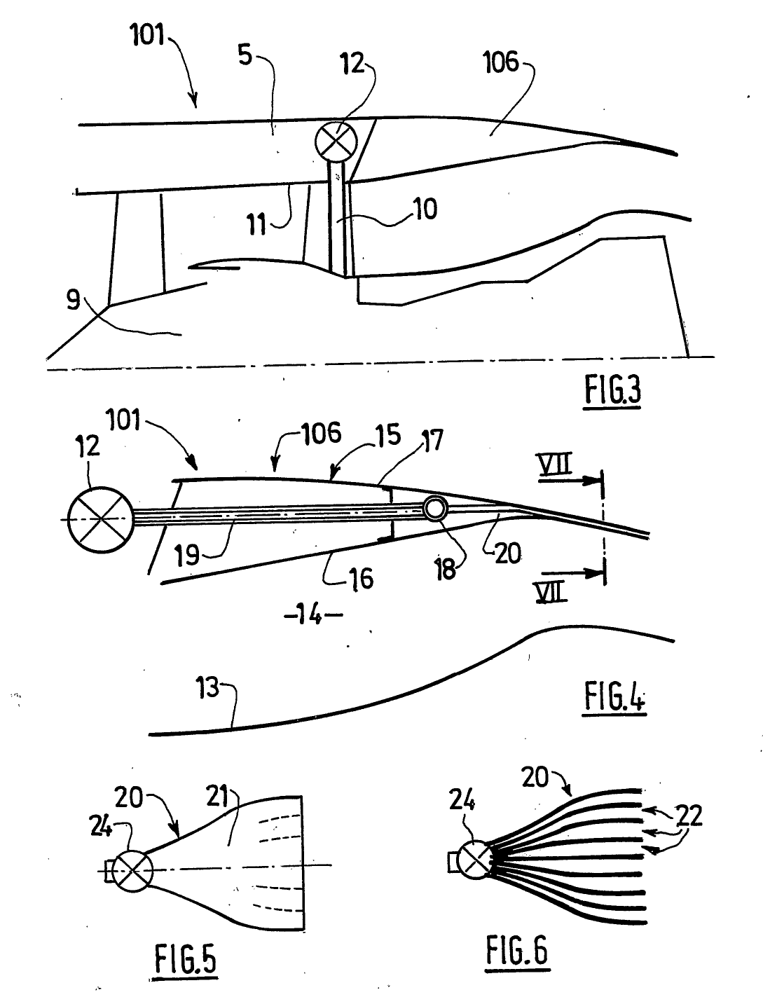

FIG. 6 is a view similar to that of FIG. 5 but of a second alternative form of embodiment of a diffuser;

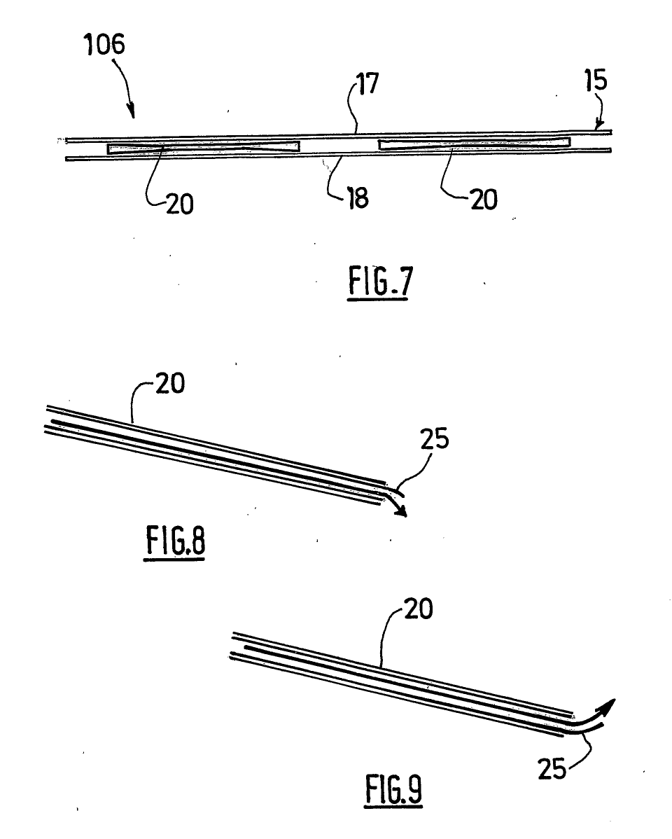

FIG. 7 is an enlarged partial schematic view in section on VII-VII of the nacelle depicted in FIG. 4;

FIGS. 8 and 9 are two enlarged schematic views of a spoiler fitted at the end of a diffuser of the nacelle depicted in FIG. 4;

FIG. 10 is a schematic view in longitudinal section of a nacelle according to the invention with a downstream external structure fitted with a thrust reverser device with telescopic pipes in the closed position;

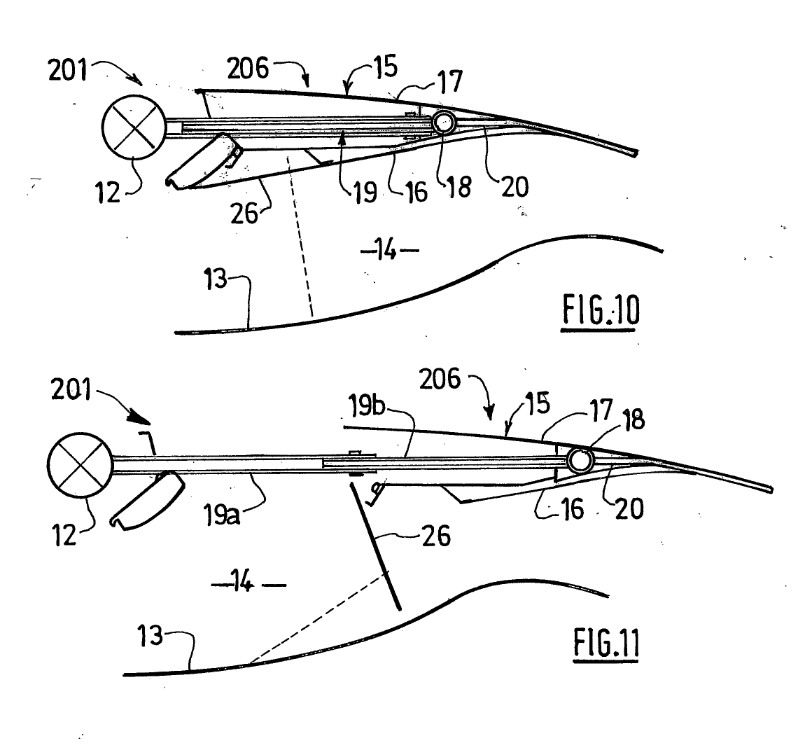

FIG. 11 is a view similar to that of FIG. 10 but with the thrust reverser device in the open position;

FIG. 12 is a schematic view in longitudinal section of one way of interfacing the supply pipe with the supply source of another nacelle according to the invention fitted with a thrust reverser device;

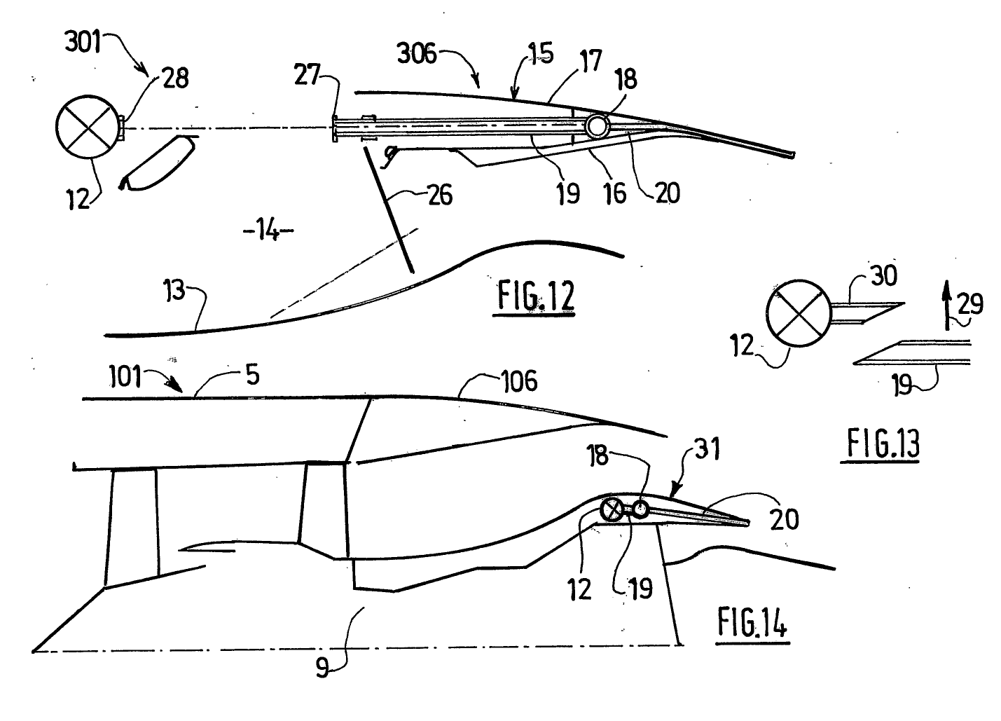

FIG. 13 is a detailed view of another way of interfacing the supply pipe with the supply source;

FIG. 14 is a schematic partial view in longitudinal section of a primary nozzle according to the invention.

In the following detailed description of the above defined figures, elements that are the same or elements that perform identical functions, will generally keep the same references.

A traditional nacelle 1, like the one depicted in FIG. 1, is attached to a wing 2 of an aircraft by means of a pylon 3. Conventionally, this nacelle 1 has a structure comprising an air intake 4 upstream of the engine, a central section 5 intended to surround a fan of the turbojet engine, and a downstream section 6 surrounding the combustion chamber of the turbojet engine. In order to reduce the unwanted noise that results from the expelled air coming suddenly into contact with the surrounding external air, the outlet of the downstream section 6 of the nacelle 1 is scalloped. This cutting is often known as “serrations” and the serrations 7, the shapes of which may vary, contribute to better homogenization of the expelled air with the external wash around the outside of the nacelle 1.

FIG. 2 is a view similar to that of FIG. 1 but of a nacelle 101 according to the invention. This nacelle 101, unlike the nacelle 1, has a downstream section 106 that has no serrations 7. However, the object of the invention does make it possible to create “fluidic serrations” that form an aerodynamic barrier that performs the same function as the serrations 7.

To do that as depicted in FIG. 3, provision is made for air to be taken from the engine 9 via at least one structural strut 10 of the internal casing 11 of the central section 5 surrounding the fan, this strut 10 having, on the one hand, a first end fixed in the engine 9 and, on the other hand, a second end that is attached to the central section 5 and connected to a command and control device 12 positioned upstream of the downstream section 106 of the nacelle 101. As a result, in this example, the engine 9 constitutes the source that supplies the air needed to operate the homogenization method. Nonetheless, as an alternative, this supply of air, or more generally of fluid, may originate from the aircraft itself, via the pylon 3 using any existing or added means capable of producing the power needed for this function, such as a compressor or an auxiliary motor (neither of which has been depicted).

With reference to FIG. 4, it may be seen that the downstream section 106 comprises a downstream internal structure 13 that forms the internal aerodynamic surface of an internal duct 14 through which the stream leaving the fan flows, and a downstream external structure 15 which can be broken down, on the one hand, into an internal wall 16 that forms the external aerodynamic surface of the internal duct 14, and, on the other hand, into a streamlining shroud 17 that forms an external aerodynamic surface.

More specifically, the command and control device 12 is placed in communication with a distribution pipe 18 by means of a supply pipe 19 situated more or less along the axis of the engine 9. More specifically still, the distribution pipe 18 and the supply pipe 19 are positioned between the internal wall 16 and the external streamlining wall 17 of the downstream external structure 15. The distribution pipe 18 is of toric configuration and is capable of distributing the air from the engine 9 over the entire downstream periphery of the downstream external structure 15. By way of an indication, in an application to a thrust reverser device of the clamshell door type (this application has not been depicted), the distribution pipe 18 will be positioned downstream of the doors.

Distributed downstream, diffusers 20 are connected to the distribution pipe 18 and designed to have a shape tailored to suit the tapering lines of the downstream end of the nacelle 101, as can be deduced in particular from FIG. 7. The makeup of a diffuser 20 may vary in terms of shapes and options according to the geometry of the desired fluidic serrations at the turbojet engine outlet.

Specifically, as depicted in FIG. 5, each diffuser 20 may be funnel-shaped with an unencumbered cavity 21, that is to say with a cavity that has no discontinuities internal to its structure. Nonetheless, it may incorporate internal arrangements into its structure, such as deflectors, evolute sections, baffles, etc. considered separately or in combination.

As an alternative and as depicted in FIG. 6, each diffuser 20 may be made up of a plurality of tubings 22, themselves produced with various diameter, routing and orientation variants.

Furthermore, an autonomous command and control system 24 is associated with each diffuser 20 so as to allow for the possibility of regulating the rate of flow of air from the distribution pipe 18. Offering this option makes it possible to improve still further the performance of the fluidic serrations according to the phases of flight of the aircraft.

As depicted in FIGS. 8 and 9, an additional option is proposed in the management of the mixing of the streams by adding, at the downstream end of each diffuser 20, a spoiler 25 introduced into said diffuser 20 over all or part of the length thereof. A spoiler 25 such as this allows the stream leaving the diffuser 20 to be oriented in the desired direction, namely toward the intrados or toward the extrados, the choice being left to those skilled in the art. It should be noted that each spoiler 25 may also be fixed in the downstream edging of the downstream external structure 15, while at the same time remaining in the continuation of its respective diffuser 20.

Furthermore, it should be clearly understood that a similar configuration may be applied to a common nozzle (not depicted) downstream of the downstream external structure 15 in the case of a combined stream nacelle.

FIGS. 10 and 11 show one example of an application of the invention to a nacelle 201 comprising a downstream section 206 that has a downstream external structure 15 that constitutes a thrust reverser device making it possible, in the conventional way, to reorient the stream flowing through the internal duct 14 using deflection cascades 26, the deployment and retraction of which are the result of translational movements of the downstream external structure 15 in the upstream or downstream directions respectively.

In this example, each supply pipe 19 is split into two telescopic pipes 19a, 19b performing a dual function, namely, on the one hand, that of conveying the air delivered by the command and control device 12 to the distribution pipe 18 and, on the other hand, that of causing the translational movement of the downstream external structure 15 at the appropriate point in time. Quite obviously, an interface may be provided in order to ensure continuous or localized sealing between the two pipes 19a, 19b, in all, retracted and deployed, positions.

FIG. 12 depicts a nacelle 301 provided with a downstream section 306 that is not suited to delivering fluidic serrations during the thrust reversal phase. The function of homogenizing the air can therefore be provided only during the direct-jet phase in which the cascades of deflection vanes 26 are retracted. For that, provision is made for the upstream end 27 of the supply pipe 19 and the outlet 28 of the command and control device 12 to be equipped with sealing means allowing said upstream end 27 to come into clean contact with the outlet 28 only when the downstream external structure 15 is in the direct-jet position.

Nonetheless, the sealed interface can be achieved at any position between the command and control device 12 and the distribution pipe 18.

For example, as depicted in FIG. 13, and more specifically in the context of a nacelle fitted with a clamshell door type thrust reverser device (not depicted), the supply interface may be achieved in a lateral portion in the direction of the arrow 29, the command and control device 12 being provided on its outlet with a tubing 30 that has a cross section corresponding perfectly to that of the supply pipe 19. This interface may be situated at absolutely any angular location on the nacelle deemed to be beneficial for better structural element operating dynamics. In addition, in a configuration such as this, the supply of air to the diffusers 20 is advantageously formed in the central spars of the fixed downstream external structure of the nacelle so as to allow the engine 9 to be accessed via the conventional opening of each half-structure around the aircraft pylon 3.

Finally, the application of the homogenization method according to the invention to a primary nozzle 31 is depicted in FIG. 14. The arrangement and configuration of the air conveying elements follow the same logic as used for applying said method to the downstream external structure 15 of the nacelle 101.

Although the invention has been described in conjunction with some specific embodiments, it is quite obvious that it is not in any way restricted thereto and that it encompasses all technical equivalents of the means described and combinations thereof where these fall within the scope of the invention.

1. A nacelle for an aircraft turbojet engine, comprising a downstream internal structure and a downstream external structure delimiting an internal duct through which a secondary or bypass stream generated by the turbojet engine flows, the downstream external structure comprising at least one distribution circuit opening to the outlet of the turbojet engine and intended to be connected to a source supplying noise-reduction fluid positioned upstream of the downstream external structure,
characterized in that the downstream external structure is equipped with a thrust reverser device capable alternately of switching from a closed position, in which it allows said stream to flow through the internal duct as a direct jet, to an open position in which it uncovers an opening in the downstream external structure so as to allow said stream to be reoriented into a deflected jet through activation of thrust reverser means,
and in that said distribution circuit comprises at least one supply pipe capable of conveying said fluid from said supply source to the turbojet engine outlet at least when said reverser device is in its closed position.

2. The nacelle as claimed in claim 1, characterized in that said supply pipe is able to connect the supply source to at least one distribution pipe.

3. The nacelle as claimed in claim 2, characterized in that the distribution pipe is of toric configuration.

4. The nacelle as claimed in claim 2, characterized in that at least one diffuser is connected to each distribution pipe, downstream.

5. The nacelle as claimed in claim 4, characterized in that each diffuser has a shape tailored to suit the tapering lines of the downstream end of said nacelle.

6. The nacelle as claimed in claim 4, characterized in that each diffuser is funnel-shaped with its cavity unencumbered or provided with internal arrangements that form deflectors.

7. The nacelle as claimed in claim 4, characterized in that each diffuser comprises a plurality of tubings that may differ from one another in terms of their diameter, routing and orientation.

8. The nacelle as claimed in claim 4, characterized in that each diffuser is coupled to an autonomous command and control system capable of regulating the rate of flow of fluid passing through said diffuser.

9. The nacelle as claimed in claim 4, characterized in that each diffuser has a downstream end to which there is attached a spoiler so that the stream leaving the diffuser can be oriented toward the intrados or toward the extrados.

10. The nacelle as claimed in claim 1, characterized in that the supply pipe is split into at least two telescopic pipes capable alternately of switching the thrust reverser device from its closed position to its open position.

11. The nacelle as claimed in claim 10, characterized in that there are means for providing sealing between the two telescopic pipes at least when the thrust reverser device is in its closed position.

12. The nacelle as claimed in claim 1, characterized in that the supply pipe comprises an upstream end equipped with coupling means capable of allowing clean contact with an interface connected directly or indirectly to the supply source.

13. An installation comprising a nacelle as claimed in claim 1, characterized in that it comprises a fluid supply source connected to each supply pipe.

14. The installation as claimed in claim 13, characterized in that it comprises at least one command and control device for regulating the rate of flow of fluid delivered by said supply source to each supply pipe.

15. The installation as claimed in claim 14, characterized in that each command and control device contains cooling means capable of cooling the fluid delivered by the supply source.

16. An aircraft comprising at least one installation as claimed in claim 13, characterized in that the supply source consists of the turbojet engine.

17. The aircraft as claimed in claim 16, characterized in that the engine is in communication with the distribution circuit via at least one supply strut.

18. An aircraft comprising at least one installation as claimed in claim 13, characterized in that the supply source is situated onboard said aircraft.
